(19) United States
(12) Patent Application Publication
(10) Pub. No.: US 2011/0166871 A1
(43) Pub. Date: Jul. 7, 2011

(54) INTEGRATED ASSESSMENTS, WORKFLOW, AND REPORTING

(75) Inventors: John C. Ryan, Boston, MA (US); Bin Zhou, San Jose, CA (US)

(73) Assignee: KONINKLIJKE PHILIPS ELECTRONICS N. V., Eindhoven (NL)

(21) Appl. No.: 12/446,980

(22) PCT Filed: Oct. 31, 2007
(86) PCT No.: PCT/US07/83078

§ 371 Date: Apr. 24, 2009

Related U.S. Application Data
(60) Provisional application No. 60/864,171, filed on Nov. 3, 2006.

(51) Int. Cl. G06Q 50/00; G06Q 10/00

(52) U.S. Cl. 705/2

(57) ABSTRACT

A risk assessment input terminal (10) displays a risk assessment template (FIG. 2) through which risk assessment information is entered of each of a plurality of patients. A care plan processor (12) assembles intervention or goal modules from a module memory (14) into care plans for the patients which are stored in a patient file memory (16). Portions of a patient's care plan that are to be delivered to a patient each day are supplied over an electronic network (22) to a patient terminal (24) for display. Some of the modules also call for tasks to be performed. The tasks to be performed each day are retrieved by a work flow processor (30) and delivered to a plurality of care professional workstations (32). Care plan professionals complete the open tasks or transfer open tasks to another care professional and close the completed tasks. A report generator (70) generates various reports.

The present application relates to electronically assisted outpatient healthcare and counseling. It finds particular application in conjunction with home healthcare, in which information is exchanged daily or on a regular basis using an interactive television system or computer system and will be described with particular reference thereto. However, it is to be appreciated that other or additional information transmission systems are also applicable.

Hospitalization is a very expensive component of healthcare. In addition to medically necessary hospitalizations, patients are often hospitalized for other, avoidable reasons. Some of these reasons are clinical, but many others are cultural, social, familial, psychological, behavioral, economic, etc. For example, patients are sometimes hospitalized because they do not have transportation to a doctors office for a preventative visit, they are at risk for falling, they fail to take their prescribed medications, their homecare giver is unstable or overwhelmed, or they are at risk for dehydration, diabetic incident, coronary event, or other medical emergency that can be avoided or the risk of occurrence reduced.

Such sources of risk are addressable and can be reduced or eliminated with an appropriate application of resources short of hospitalization. Assessments are sometimes performed to identify the risk of hospitalization. However, once a source of a risk is identified, the needed follow through to mitigate the risk is not always performed by the responsible caregiver. For the individual caregiver, satisfactory tools are not available to track multiple different risks across a population of patients. There is currently no satisfactory organized method for hand-offs between caregivers. Finally, current means for management to track the closure rate of outstanding risk mitigation factors often break down leaving gaps in the delivery of healthcare and social services.

The present application overcomes the above-referenced problems and others.

In accordance with one aspect, it defines a workflow to mitigate risk, organize collaboration among healthcare providers to execute an organized workflow, store key documents, close each open issue, and track performance.

In accordance with another aspect, an electronic patient assistance system is provided. An intervention or goal module memory stores a plurality of modules. A patient care plan processor assembles one or more of the modules into a patient care plan for each of a plurality of patients. The care plan for each of the plurality of patients is stored in a memory. A plurality of patient terminals disposed at patient locations are connected with the care plan processor by an electronic network. The results of a patient risk assessment are entered through a risk assessment input terminal. The care plan processor assembles the care plans for each patient based on the risk assessment information from the risk assessment input terminal.

In accordance with another aspect, a method provides electronic assistance to a patient. A risk assessment for each patient is entered electronically. Modules are assembled into a care plan based on the input risk assessment. The assembled care plan for each of the plurality of patients is stored. Periodically, segments of the care plan are delivered to corresponding patients.

One advantage resides in improved risk assessment.

Another advantage resides in a structured workflow for systematically removing sources of risk.

Another advantage resides in improved routing of specific tasks and recording the status of each.

Another advantage resides in generating reports with meaningful metrics concerning operational management.

Another advantage resides in the assembly of a personalized, yet highly automated, controlled care experience for each patient.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

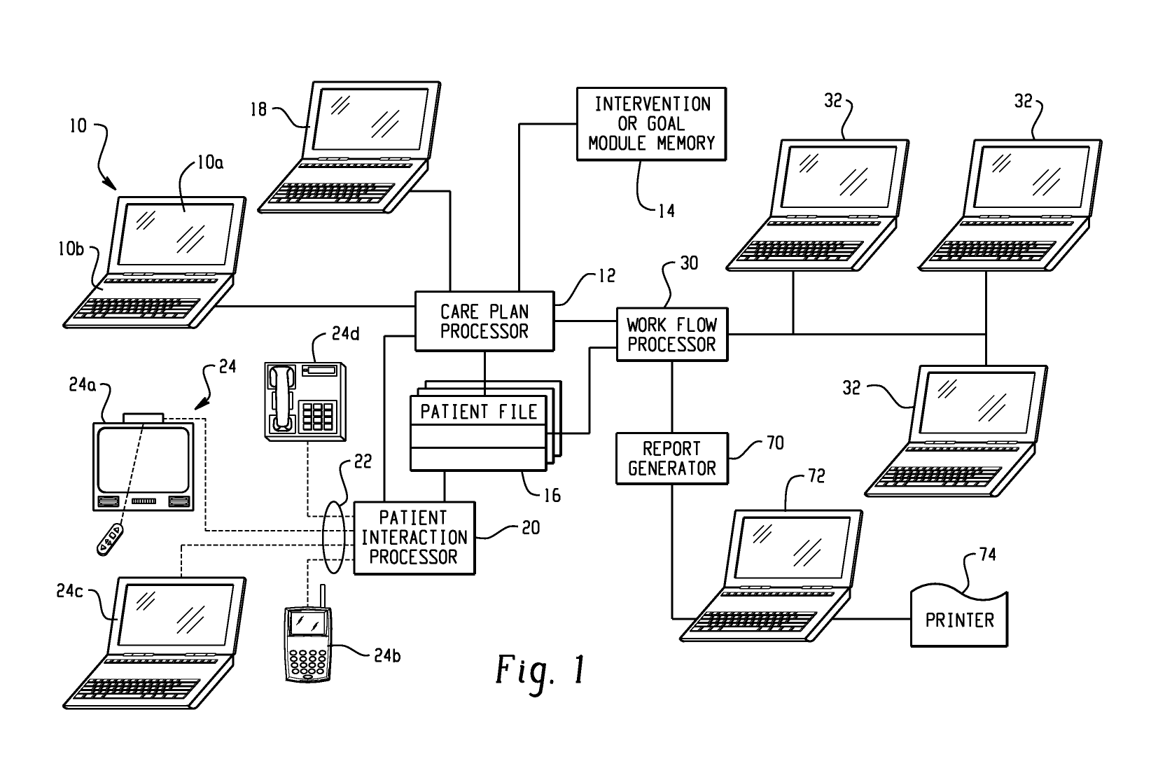

FIG. 1 is a diagrammatic illustration of an electronic system for making patient assessments, routing and controlling workflow, and reporting.

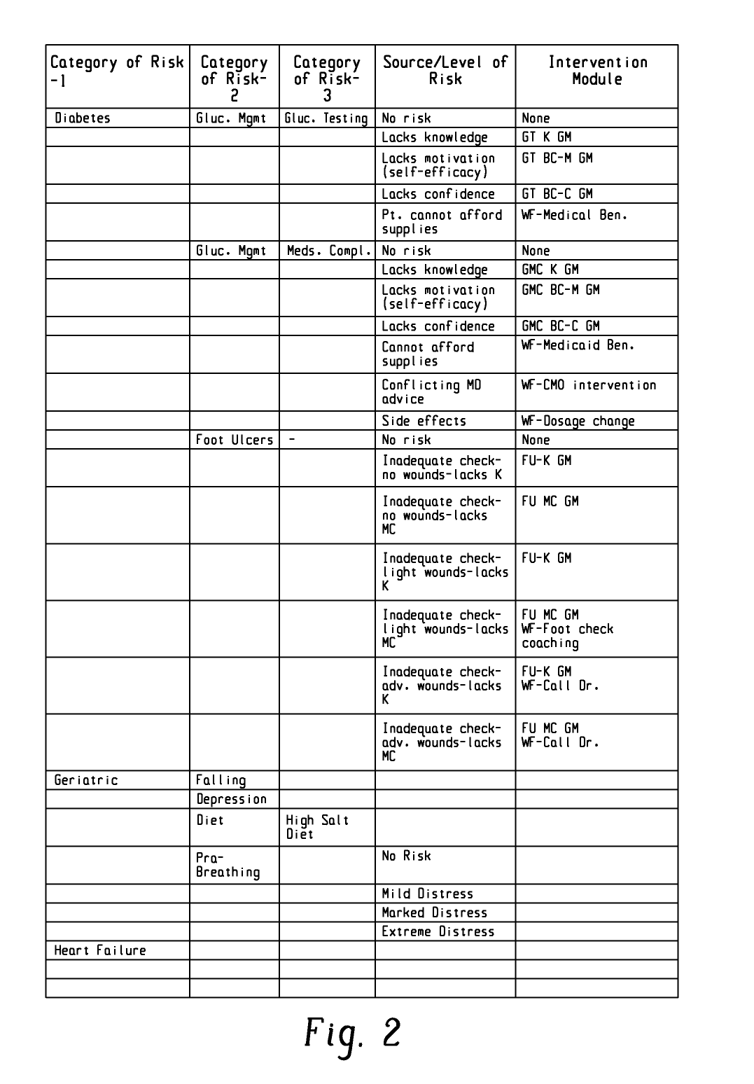

FIG. 2 is a risk assessment template that is displayed and filled-in on a risk assessment input terminal of FIG. 1.

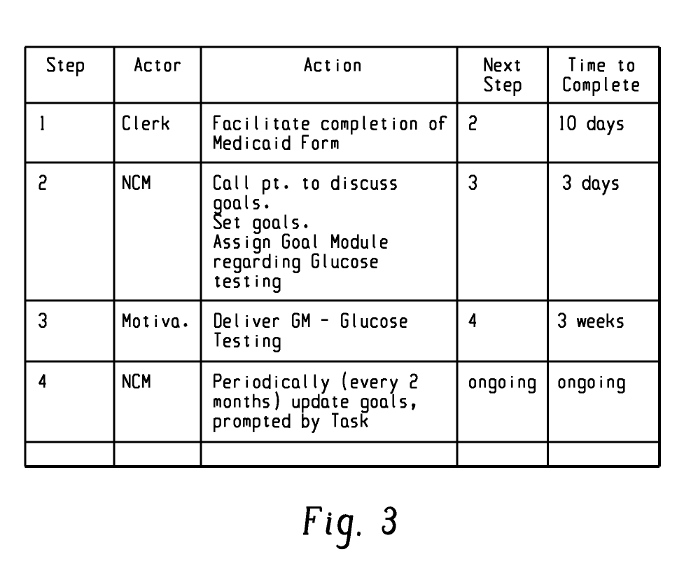

FIG. 3 is a design template.

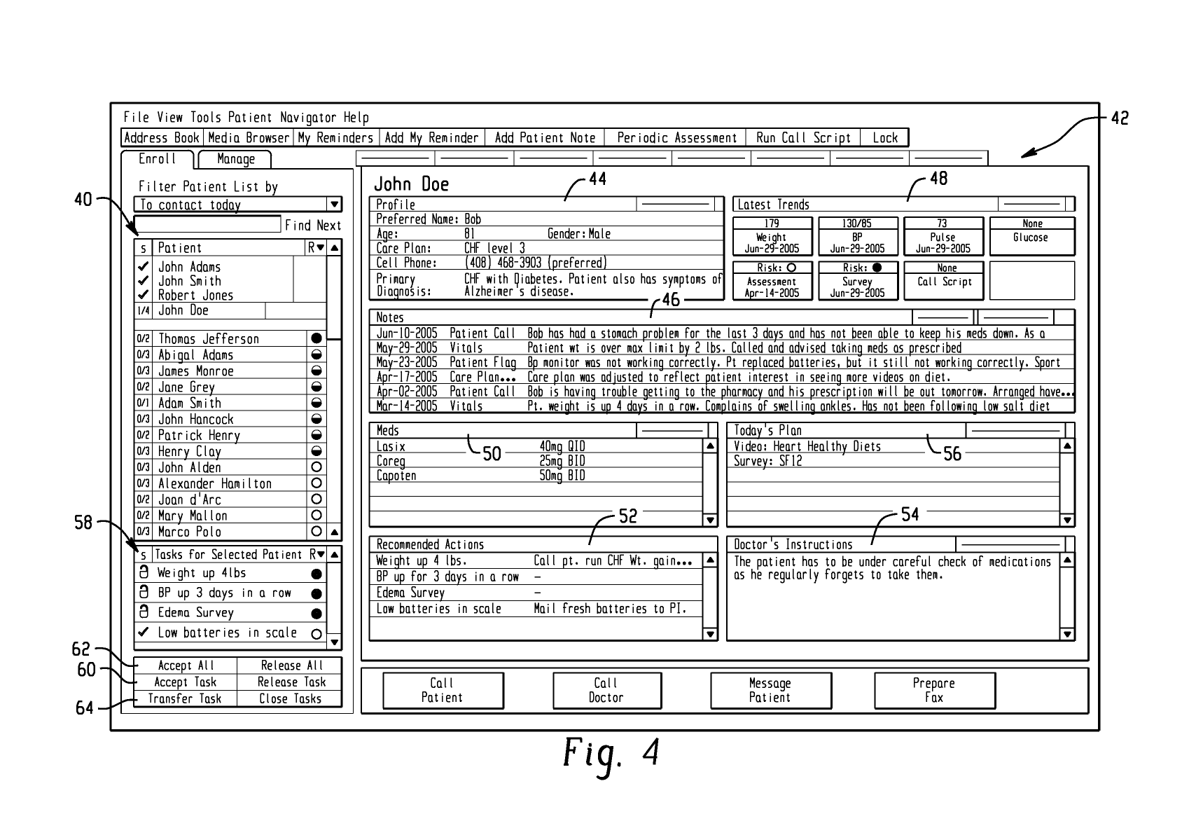

FIG. 4 illustrates a sample of a workspace displayed on the care professional monitors of FIG. 1 in a management mode.

With reference to FIGS. 1 and 2, a nurse or other care professional conducts an assessment of a patient using a risk assessment entry terminal 10 (FIG. 1) which displays a risk assessment template, such as the template of FIG. 2, on the video monitor 10a. The template is designed by a care plan designer in advance to define categories of risk to be addressed by the system, define a source or level of risk, associate each source or level of risk with an intervention or goal module, and define a call script to aid the nurse or care professional in determining the source or level of risk. Typically, when the source or level of risk is none or no risk, no intervention module is associated with it.

With reference to FIG. 3, a care plan designer defines, also in advance, the steps in a recommended intervention against each category of risk for each and source or level of the risk. Each intervention or goal module may include tools such as education via video, monitoring patients vital signs, conducting surveys, telephone contact, mailings, and the like. Preferably, the intervention also includes incentives and simulations, regular phone coaching, assisting in obtaining medical or social benefits, transportation, or internal resources such as home healthcare, social workers, and the like. For each of the actions, the care plan designer assigns an appropriate person who has primary responsibility for each of the roles (FIG. 3, column 2). For example, a clerk may have primary responsibility for facilitating the completion of Medicaid forms. A nurse care manager may have the primary responsibility for calling the patient to discuss goals, set goals, assign goal modules, and the like. Each of the intervention or goal modules is typically assigned in a preferred order of performance (column 4), with a schedule for completion (column 5).

Returning now to the risk assessment, the care professional works with each of a plurality of patients in person or by telephone to conduct an initial interview for enrolling a new patient or periodic assessments as may be called for by the care plan designer. The care professional utilizes a call script to guide the conversation in order to record the appropriate risk levels in the FIG. 2 template which is displayed on the monitor of the risk assessment terminal 10. The care professional uses an input device 10b, such as a keyboard, touch screen, or the like, to select the appropriate entries in the template. Looking to the example of FIG. 2, the care professional may first inquire about diabetes. If diabetes is an issue, then the remaining areas of inquiry in the diabetes section are addressed. If diabetes is not a risk, the care professional moves to the next category. The display on the risk assessment terminal may open or close subcategories in columns 2 or 3 depending upon whether diabetes is or is not a risk factor for the current patient. Alternately, the primary caregiver or doctor can designate limited categories to be assessed.

Looking again to the diabetes example, the care professional inquires about glucose management and glucose testing. Various sources and levels of risk can be selected, such as no risk, lacks knowledge, lacks motivation, lacks confidence, or cannot afford supplies. The care professional notes each source or level of risk which applies to this patient. For example, if the patient cannot afford supplies, the care professional clicks on the appropriate box which may cause it to be highlighted or change color. Associated with each source or level of risk is an intervention module designated in the last column.

One or more care plan processors 12 assemble the intervention or goal modules designated in the risk assessment into a care plan for that patient. More specifically, the care plan processor 12 retrieves the appropriate intervention, goal or other modules from an intervention or goal module memory 14. Each of the modules typically includes a plurality of segments scheduled for different days. This assembly of segments will schedule care experiences (patient-driven, nurse driven) for months or years into the future. For example, a module to stop smoking might include a series of educational and motivational video clips to be played one a day to educate and inspire the patient to quit smoking. The module would typically also specify the interval, such as daily for a month, reducing to biweekly and possibly to weekly or even monthly over time. In addition to the video clips, the module may also include questionnaires or quizzes through which the patient can indicate the progress of his/her learning and stopping smoking, or numeric entry so that the patient can enter and track measurable goals such as miles walked or number of fruit and vegetable servings per day. Medical measurements, such as lung capacity, can be entered through questionnaires or by directly interfacing with the measuring device. The goal module may also include workflow elements, such as personal calls from a medical professional or a counselor trained to help smokers to quit, at specified intervals.

The information for each of the numerous patients in the system can be stored in various ways. As one example, each patient has a memory area or electronic file 16 with medical records and a virtual calendar which carries daily instructions for videos to be displayed, surveys to be given, workflow actions, and the like. Another medical or care input terminal 18 for other medical or care related information enables other medical information as may be appropriate to be input into the patient's file 16. For example, a medical professional can enter future medical appointments, additional workflow elements such as telephone follow-ups with the patient regarding various medical issues, changes or additions to the goal modules prescribed for each patient, new prescriptions or medications, and the like.

A patient interaction processor 20 retrieves each of the segments elements of each of the modules of each patient's care plan, such as video presentations, quizzes, or surveys, to be presented to the patient each day or at other intervals and communicates them in encrypted format over a communications network, such as a cable broadband network, a telecomm BB network (wired or wirless), POTS, etc. 22. The patient interaction processor 20 delivers or causes to be delivered the material which is sent directly to the patient and does not require personal interaction with a medical professional. Each patient has a patient terminal 24, such as a conventional television set with a set top box 24a programmed to interface with the patient interaction computer 20, which receives each of the items to be displayed to the patient. The patient's terminal can also be a wireless device 24b, a desktop PC 24c, or even a traditional wired (POTS) telephone 24d (for messages, surveys, reminders). A patient input device 26, such as the remote control like for the television set, the keyboard of a PC, the keypad of a wireless device, or the number pad of a POTS phone can be used by the patient to answer the quizzes or surveys, input medical measurements such as weight or blood pressure taken by the patient, and other information to be communicated from the patient terminal back to the patient interaction processor to be entered into the patient file.

For example, the set top box can store a series of pre-recorded video segments which are periodically released by the central server or the video segments can be supplied by streaming video for display on a designated channel. Questionnaires and quizzes can be answered with a dedicated remote with keys labeled to input “yes”, “no”, numerical values, and optionally, text answers. If text is to be entered regularly, the remote can be in the form of a wireless keyboard and mouse. A workflow processor 30 retrieves interventions and other tasks from the patient calendar 16 which require professional interaction at a current time. For example, the tasks can be retrieved daily. The workflow processor also receives patient inputs which should be addressed by a care professional, such as from medical measurements, answers to quizzes or surveys, and the like, for incorporation into a workflow for routing to the appropriate care professional. Optionally, this input can be filtered such that only medical measurements or survey questions which are out of a normal range or are otherwise flagged as troublesome are conveyed to the care professional. These filters can be set on a patient-specific basis. Workspace screens are displayed on each of a plurality of care professional workstations 32. These display the interventions and other items which need staff action. In the workflow display of FIG. 4, there is a patient listing 40 which lists each of the patients which require action by the staff. The various staff members click on one of the patients in the list having an open intervention to bring up the patient's summary screen 42. This screen lists the patients profile 44, notes from prior patient contacts 46, latest medical information 48, and current medications 50. The summary screen also includes a list 52 of recommended actions and a display 54 for doctor's instructions. The summary screen further includes a list of today's activities 56. The display further includes a task list 58 identifying tasks which a staff member is to perform today for the selected patient.

A care professional selects a patient with open items, opening the patient's summary 42 and task list 58, and accepts one of the tasks from list 58 by interacting with icon 60 or all of the tasks by interacting with icon 62. As each task is completed, the care professional marks the task as completed until all of the accepted tasks are closed. The care professional can also transfer a task by interacting with icon 64. For example, the care professional may initially address tasks such as calling the patient to discuss an increase in weight or blood pressure. Upon completion of these tasks, the care professional may transfer a task that is performed by a different care professional, such as to a clerk to send out forms to the patient for signature. Similarly, if the first care professional tries to telephone the patient to complete one of the tasks and finds that the patient is not at home, they can release that task and complete those tasks which they can complete. Upon selecting another patient, the present patient will remain listed with open tasks to be completed today so that the same or another staff member may address the still-open task later in the day.

In one embodiment, the workflow processor routes the patients to the care professional in an order in which the tasks are to be completed. As each care professional completes their task and closes it, the workflow processor automatically forwards the intervention to the next care professional in the process. When all the tasks are closed, they can be grouped logically on an assessment or notes screen. The care professionals can also see the workflow process and their part in it, as well as the other actors in the workflow.

A report generator or processor 70 is controlled by a report workstation or terminal 72 to generate reports, which can be printed on a printer 74. Typical reports include an overdue task report, an evaluation reports showing the efficiency of each care professional, numbers of overdue tasks, and other care professional evaluation aids. Another type of report evaluates the effectiveness of each of the care plans, such as evaluating a percentage of the patients on each module of the care plan who achieve a goal, come within a preselected percentage of the goal, or the like. Care plans which include human contact by a staff member can be compared with those that do not. Other types of reports that can be generated are patient progress or cost reports. For example, insurance providers can be provided with information regarding recovery rates of their insureds, cost per insured patient, cost for various classes of patients, and the like. Other reports as might be desirable for supervisors, hospitals, insurers, government agencies, and the like may also be provided.

Although the care plan processor, the patient interaction processor, the workflow processor, and the report generation processor are illustrated as separate elements for ease of conceptual understanding, it is to be recognized that these may be parts of a single computer or processor, part of a larger or smaller array of processors, and the like. Also, although the workstations or terminals 10, 18, 32, and 72 are described as having dedicated functions for ease of explanation, it is to be appreciated that each workstation or terminal can be used to perform more than one of these functions and each function can be performed on other workstations or terminals.

Although described with reference to a home healthcare embodiment, the present system and method has numerous other applications. For example, additional actors can be added to the work flow. The patient's primary care doctor can be assigned specific tasks in the work flow, such as “titrate medications per guidelines” or “run cholesterol test, per guidelines”. The patient's supplier of medical supplies or specific services (one time or repeating) can be included in the workflow, such as “set up patient on regular shipments of lancets and strips” or “ set up patient for regular home healthcare visits” or “set up patient for regular delivery of heart medications (Lasix, 10 mg, 90 day supply)”. The patient's family and friends can be brought into the workflow, such as “confirm that you will be able to take your mother to her tests on Tuesday at 10:00 am ‘confirm’ in this e-mail below”. Government agencies or services can be brought into the workflow, such as “Patient is unaware of medical benefit eligibility requirements. Please mail eligibility packet and follow-up in five days. We will send you another task to do so”. Various other actors in other segments of the healthcare industry can also be added or substituted into the workflow.

The present system and method can also be extended to other segments of the healthcare industry. For in-patient hospital settings, the present system and method can be used to manage workflow between multiple specialists, nurses, labs, food service, and the like to insure that standards of clinical care and standards of customer service are maintained. In employer settings, the present system and method can be applied to identify employees at risk for lost days due to injury or stressful family situations. As another example, in educational settings, the present system and method can be used to identify children who are developing poor long-term health behaviors, e.g., diet, exercise, stress, dental care, hygiene, etc. Numerous other examples will, of course, be apparent to those of ordinary skill in the art.

The present system and method is also applicable to industries other than healthcare. For example, it can be applied to other industries in which there is a need to diagnose the risks of a complex unknown unit within a larger population, assemble customized interventions according to the identified risks, and execute a structured, multi-actor workflow to insure that identified risks are eliminated. Exemplary applications include the education industry, such as to identify and intervene for specific students at risk of not graduating. As another example, from the education industry, it can be used to identify and intervene for students who are at a risk of committing or being the victims of violence. In the used car industry, it can be used to standardize the assessment of purchased used cars and the standard for refurbishment. Expansions and other applications in other industries will again be readily apparent to those of ordinary skill in the art.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. An electronic patient assistance system comprising:
an interventional or goal module memory (14) which stores a plurality of intervention or goal modules;
a patient care plan processor (12) for assembling one or more of the modules into a patient care plan for each of a plurality of patients;
a memory (16) which stores at least the patient care plan for each of the plurality of patients;
a plurality of patient terminals (24) disposed at a plurality of patient locations and connected with the care plan processor (12) by an electronic network (22); and
a risk assessment input terminal (10) through which patient risk assessment information is entered, the care plan processor (12) assembling the care plans for each patient based on the risk assessment information from the risk assessment input terminal (10).

2. The system according to claim 1, wherein the risk assessment input terminal (10) includes:
a display monitor (10a) which displays a risk assessment template which guides a care professional interviewing each patient with a script or template which guides the questions to be asked of each patient; and
an input portion (10b) for entry of risk assessment information.

3. The system according to claim 2, wherein the risk assessment template includes:
at least one risk column or section listing each of a plurality of risk categories; and
a source or level of risk column or section in which the care professional inputting the risk information can select among a plurality of sources or levels of risk for each risk category.

4. The system according to claim 3, wherein the risk assessment input terminal (10) associates the selected risks and risk levels with corresponding modules.

5. The system according to claim 3, wherein some of the modules include tasks to be performed by care professionals at various times in a care plan and further including:
a workflow processor (30) which retrieves the tasks which are to be performed and routes them to a plurality of care professional terminals (32) for human interaction by a care plan professional.

6. The system according to claim 1, wherein some of the modules include tasks to be performed by care professionals at various times in a care plan and further including:
a workflow processor (30) which retrieves from the memory (16) the tasks which are to be performed at a current time and routes them to a plurality of care professional terminals (32) for human action.

7. The system according to claim 6, wherein the workflow processor (30) generates displays for the care professional terminals (32) which list patients with open tasks to be performed, and a list of the open tasks for at least a selected patient identified in the display as having open tasks.

8. The system according to claim 7, wherein the workflow processor (30) is programmed to:
receive input from a care professional indicating a task is complete and marking the task on the display as complete;
in response to all open tasks for a patient being complete, controlling the display to indicate that the patient's tasks are complete or removing the patient with completed tasks from the screen.

9. The system according to claim 8, wherein the workflow processor (30) is further programmed to receive transfer requests from one care professional terminal (32) requesting that responsibility for one or more open tasks be transferred to a care professional at another of the care professional terminals (32).

10. The system according to claim 8, further including:
a report generator (70);
a report generator terminal (72) for controlling the report generator to generate selected reports.

11. The system according to claim 10, wherein the report generator is programmed to at least one of:
generate a report showing a number of open tasks;
generate a report showing a number of open tasks by care professional;
generate a report showing cost per patient;
generate a report showing efficacy of the modules;
generate a report showing efficiency of the care professionals.

12. An electronic assistance system comprising:
an interventional or goal module memory (14) which stores a plurality of intervention or goal modules;
a care plan processor (12) for assembling one or more of the modules into a care plan for each of a plurality of recipients;
a memory (16) which stores at least the care plan for each of the plurality of the care plan recipients;
a plurality of recipient terminals (24) disposed at a plurality of recipient locations and connected with the care plan processor (12) by an electronic network (22); and
a risk assessment input terminal (10) through which risk assessment information is entered, the care plan processor (12) assembling the care plans for each recipient based on the risk assessment information from the risk assessment input terminal (10).

13. A method of providing electronic assistance to a patient comprising:
electronically entering a risk assessment for each of a plurality of patients;
assembling modules into a care plan based on the entered risk assessment;
storing the assembled care plan for each of the plurality of patients; and periodically delivering segments of the assembled care plans to corresponding patients.

14. The method according to claim 13, wherein the risk assessment is input by electronically selecting entries in a risk assessment template displayed on a monitor; and,
correlating the entries in the risk assessment template with the modules to be assembled into the care plan.

15. The method according to claim 14, wherein levels or sources of each risk listed in the risk assessment template are input.

16. The method according to claim 15, wherein the modules include video clips to be delivered to the corresponding patient at selected times over a plurality of days and include tasks to be performed by care professionals at various times over the plurality of days, and further including:
retrieving tasks which are to be performed at a current time and routing the retrieved tasks to electronic terminals for human interaction by a care plan professional.

17. The method according to claim 13, wherein some of the modules include tasks to be performed by care professionals at various times during a care plan, and further including:
retrieving tasks from the assembled care plans which are to be performed at a current time and routing them to electronic terminals of a plurality of care professionals.

18. The method according to claim 17, further including:
on the care professional terminals (32), displaying a list of patients with open tasks to be performed and displaying a list of the open tasks for a selected patient which is identified in the display as having open tasks.

19. The method according to claim 18, further including:
receiving an input from a care professional indicating a task has been completed;
marking the task as complete on the open task list; and,
in response to all open tasks for a patient being complete, controlling the display to indicate that the patient's tasks are complete or removing the patient with completed tasks from the list of patients with open tasks.

20. The method according to claim 19, further including:
transferring open tasks from one care professional to another.

21. The method according to claim 13, further including generating at least one of:
a report showing open tasks;
a report of open tasks by care professional;
a report illustrating cost per patient;
a report showing efficacy of the modules;
a report showing efficiency of the care professionals.

22. An electronic patient assistance system including means for performing each of the steps of claim 13.

23. A computer medium or processor programmed to perform the method of claim 13.

24. A method of designing a care plan comprising:
defining risks and levels of the risks;
assigning interventional actions for the levels of the risks.

25. The method according to claim 26, wherein the interventional actions include at least one of: showing a video, caregiver contact with a patient, review of questionnaire or survey results by a caregiver, and attending to insurance issues.

26. The method according to claim 24, further including:
creating a template with the defined risks and levels of risk.

27. A risk assessment template comprising:
at least one risk column listing each of a plurality of risk categories; and a source of level of risk column listing sources or levels of risk for each risk category.

28. The template according to claim 27 further including:
a column which displays care plan modules corresponding to the sources or levels of risk.

29. A computer programmed to display the template of claim 27 and receive inputs selecting sources or levels of risk.

30. A system for mitigating risks comprising:
at least one input terminal for inputting identified risks of a complex unknown unit within a larger population; and,
one or more processors programmed to assemble customized interventions according to the identified risks and execute a structured, multi-actor workflow to ensure that the identified risks are mitigated.
